(19) United States
(12) Patent Application Publication
(10) Pub. No.: US 2006/0270953 A1
(43) Pub. Date: Nov. 30, 2006

(54) Massage apparatus

(76) Inventor: Ching-Yiao Tsai, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/137,547

(22) Filed: May 26, 2005

(51) Int. Cl. A61H 1/00

(52) U.S. Cl. 601/46; 601/101; 601/103

(57) ABSTRACT

The present invention provides a massage apparatus, which comprises a vibration device that has four supports on its lateral sides respectively; a mount board is installed on the vibration device, and multiple wooden massage heads are installed on the mount board. The massage apparatus of the present invention has diversified applications via that the wooden massage heads can be changed according to the size, quantity, arrangement, and shape demanded by the user. Further, as the wooden massage heads absorb essential oil and herb liquor, the vibration and rub of massage enables the essential oil to release into air and the herb liquor to penetrate into skin.

### BACKGROUND OF THE INVENTION

1. Field of the Invention

The present invention relates to a massage apparatus, particularly to a diversified, easily-operated, and aromatherapeutic massage apparatus.

2. Description of the Related Art

Progressing with times, people pay much attention to health now, and massage is the most prevalent selection in healthcare. There are various kinds of massages, such foot sole massage, acupoint massage, face massage, and massages of other portions of the body. The foot sole massage is the most popular one, having the following advantages: 1. improving the immunity, 2. promoting the vitalization of cells, 3. enhancing the nervous reflex, 4. raising the function of endocrine system, 5. stimulating the peristalsis of stomach and bowels, 6. affording the relaxation of muscle, etc. Further, the massage with essential oil or herb liquor will achieve the best effect of massage, owing to the therapeutic action of the essential oil or the herb.

There are various kinds of massage instruments in the market, such as massage roller, shoes for foot sole massage, electrically-driven massage chair, etc.; however, there is no massage apparatus with all three functions of aromatherapy, massage, and electrical-drive. As the tri-functional massage can afford very much comfort, the massage apparatus integrating those three functions is then desired and anticipated by people.

In re those mentioned above, the inventor, who has many years' experience of designing and fabricating massage apparatuses, proposes a diversified, easily-operated, and aromatherapeutic massage apparatus after a long-term research.

### SUMMARY OF THE INVENTION

The primary objective of the present invention is to provide a massage apparatus, wherein the wooden massage heads absorb essential oil or herb liquor and the vibration and rub of massage will enable the essential oil to vaporize or the herb liquor to penetrate into skin.

Another objective of the present invention is to provide a massage apparatus, whose application is diversified via the replaceable massage heads of different sizes, quantities, shapes, and arrangements.

The massage apparatus of the present invention comprises a vibration device, and at least three supports are installed on the lateral sides of the vibration device; a mount board is installed on the vibration device, and at least one wooden massage head is installed on the mount board; the swing of the vibration device drive the wooden massage heads to operate.

Via the embodiments described below in cooperation with the attached drawings, the objectives, technical contents, characteristics, and accomplishments of the present invention are to be more easily understood.

### BRIEF DESCRIPTION PF THE DRAWINGS

FIG. 1 is a perspective view of the present invention.

FIG. 2 is a front view of the present invention.

FIG. 3 is a schematic diagram showing that the wooden massage heads are replaced by other ones of different sizes in the present invention.

FIG. 4 is a schematic diagram showing that the quantity of the wooden massage heads is changed in the present invention.

FIG. 5 is a schematic diagram showing that the massage apparatus of the present invention operates in another way.

### DETAILED DESCRIPTION OF THE INVENTION

The present invention is a massage apparatus, which can apply to foot sole massage, abdomen massage, waist massage, face massage, or massages of other portions of body, and which can cooperate with a specific therapeutic liquid, such as an essential oil or a herb liquor, to promote the effect of massage.

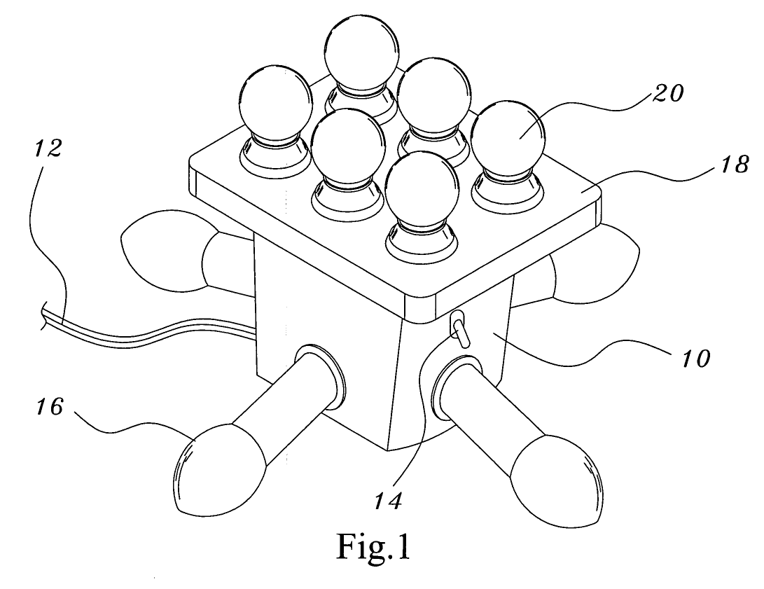

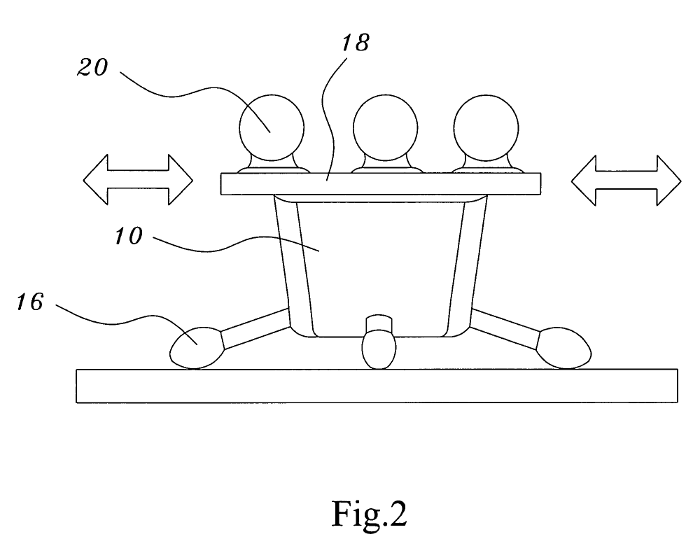

As shown in FIG. 1 and FIG. 2, the massage apparatus of the present invention comprises a vibration device 10, which has an electrical equipment, and in this embodiment, the equipment is a power cable 12, which provides the vibration device 10 with power. The vibration device 10 has a control switch, which is used to turn the power on/off and to select the vibration frequencies of the vibration device 10. Further, the vibration device 10 can also has a rechargeable battery to store electrical energy, which enables the massage apparatus of the present invention to be conveniently carried about.

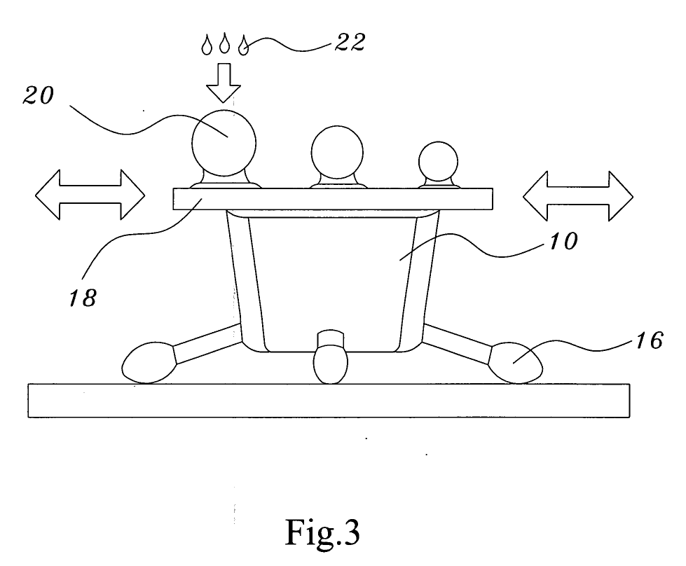

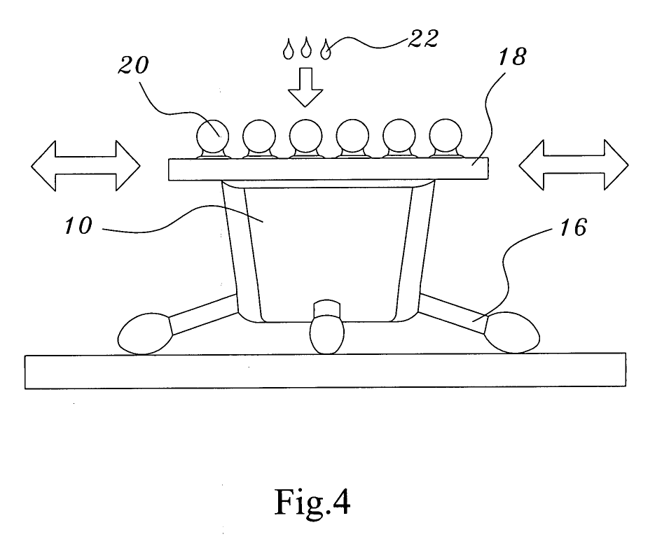

The vibration device 10 has four supports 16, which are obliquely installed on four lateral sides of the vibration device 10 respectively. When the massage apparatus of the present invention is placed on the floor, the vibration device 10 is floated away from the floor by those four supports 16. A mount board 18 is installed on the vibration device 10, and a motor (not shown in the drawings), which drives the mount board 18 back and forth, is installed inside the vibration device 10. Six wooden massage heads 20 are installed on the mount board 18, and the wooden massage heads can be fixed to the mount board 18 via screwing, rabbetting, scarfing, or press-fitting. The motor inside the vibration device 10 rotates to drive the wooden massage heads 20 back and forth horizontally. Further, the wooden massage heads 20 on the mount board 18 can be changed according to the size, quantity, arrangement and shape demanded by the user, as shown in FIG. 3 and FIG. 4. Furthermore, the liquid 22 having a specific therapeutic effect, such as an essential oil or a herb liquor, can be applied to the wooden massage heads 20, and as the wooden massage heads 20 can absorb the liquid 22 having a specific therapeutic effect, when performing massage, the essential oil will vaporize to perfume or the herb liquor will penetrate into skin to create a therapeutic effect via the rapid vibration and rub of the wooden massage heads 20.

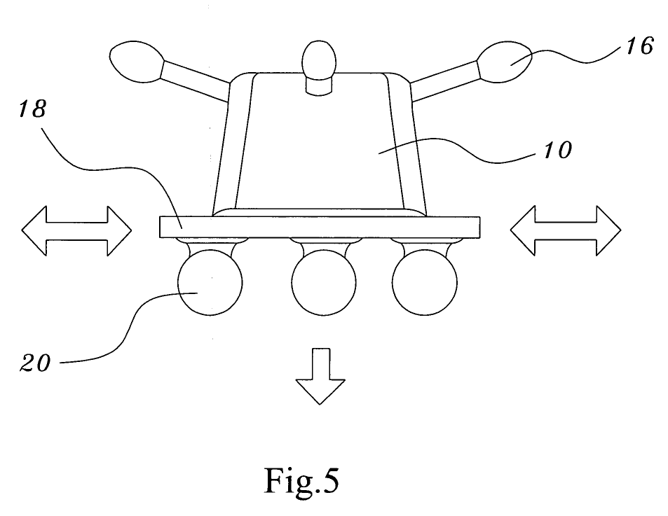

When the massage apparatus of the present invention is placed on the floor, it can perform the foot sole massage, and there are still many other ways to utilize the massage apparatus of the present invention. As shown in FIG. 5, the user can hold the supports 16 and face the wooden massage heads to the portion to be massaged, such as back, waist, abdomen, and face; thus, the massage apparatus of the present invention has pretty diversified applications.

Accordingly, the massage apparatus of the present invention can simultaneously achieve two kinds of therapeutic effects via that the wooden massage heads 20 absorb the essential oil and/or the herb liquor, and that the vibration and rub of massage enables the essential oil to vaporize and the herb liquor to penetrate into skin. Further, the massage apparatus of the present invention has diversified applications via that the wooden massage heads 20 can be changed according to the size, quantity, arrangement, and shape demanded by the user.

Those described above are only the present invention's preferred embodiments, which are to enable the persons skilled in the art to understand, make, and use the present invention and are not intended to limit the scope of the present invention. Any equivalent modification and variation according to the structures, shapes, characteristics, and spirit of the present invention is to be included inside the scope of the claims of the present invention.

What is claimed is:

1. A massage apparatus, comprising:
a vibration device, having at least three supports on the lateral sides thereof;
a mount board, installed on said vibration device; and
at least one wooden massage head, installed on said mount board and driven by the swing of said vibration device.

2. The massage apparatus according to claim 1, wherein a specific liquid can be applied to said wooden massage head, which absorbs said specific liquid.

3. The massage apparatus according to claim 2, wherein said specific liquid is either an essential oil or a herb liquor.

4. The massage apparatus according to claim 1, wherein said vibration device has a motor installed thereinside, which enables said mount board to vibrate back and forth.

5. The massage apparatus according to claim 1, wherein said supports are obliquely installed on the lateral sides of said vibration device and float said vibration device away from the floor.

6. The massage apparatus according to claim 1, wherein said massage apparatus can be applied to foot sole massage, abdomen massage, waist massage, face massage, and massages of other portions of body.

7. The massage apparatus according to claim 1, wherein said wooden massage head can be changed according to the size, quantity, arrangement, and shape demanded by the user when the quantity of said wooden massage head is plural.

8. The massage apparatus according to claim 1, wherein said vibration device has an electrical equipment, which provides power for said vibration device.

9. The massage apparatus according to claim 8, wherein said electrical equipment comprises a rechargeable battery, which provides stored electrical power for said vibration device.

10. The massage apparatus according to claim 1, wherein said vibration device further has a control switch, which control the vibration frequency of said vibration device.

11. The massage apparatus according to claim 1, wherein said wooden massage head can be installed on said mount board via screwing, rabbetting, scarfing, or press-fitting.
